(19) United States
(12) Patent Application Publication
(10) Pub. No.: US 2021/0378392 A1
(43) Pub. Date: Dec. 9, 2021

(54) REMOVABLE HANDLE COVER WRAPPABLE AROUND A BAR

(71) Applicants: Argy Petros, Pompano Beach, FL (US); Hendrik Theron, Boca Raton, FL (US)

(72) Inventors: Argy Petros, Pompano Beach, FL (US); Hendrik Theron, Boca Raton, FL (US)

(21) Appl. No.: 17/339,987

(22) Filed: Jun. 5, 2021

Related U.S. Application Data
(60) Provisional application No. 63/035,040, filed on Jun. 5, 2020.

(51) Int. Cl. A45F 5/10

(52) U.S. Cl. CPC A45F 5/10; B62B 5/069; A45F 2005/1013

(57) ABSTRACT

Disclosed is a removable handle cover device for wrapping around a bar to prevent a user's hands to be in direct contact with the bar. The handle cover comprises at least one piece of material wrappable around a handle bar, one or more spring steel elements, and a releasing mechanism for quickly removing the handle cover from the bar. The device is operative to be quickly installed and removed from the handle bar by the user with a single action, while physically isolating the user's hands from the bar. The handle cover is able to prevent the user from being exposed to contaminants on or to contaminate the surface of the bar by increasing the efficacy in the implementation and performance of proven healthy practices, reducing the risk of contamination with and spreading of contagious diseases.

### CROSS REFERENCE TO RELATED APPLICATION

This application is based upon and claims priority from co-pending U.S. Provisional Patent Application Ser. No. 63/035,040, entitled “REMOVABLE HAND PROTECTOR WRAPPABLE AROUND A BAR,” filed with the U.S. Patent and Trademark Office on Jun. 5, 2020, by the inventor herein, the specification of which is incorporated herein by reference.

### FIELD OF THE INVENTION

The present disclosure relates generally to health protection devices. More particularly, the present invention relates to removable protective coverings wrappable around a bar for preventing a user's hands from being in direct contact with the bar.

### BACKGROUND OF THE INVENTION

A number of health protection devices and practices have been disclosed within various industries for preventing a person from touching a potentially contaminated surface or contaminating such surface. In particular, covering a surface or wearing a personal protective equipment, such as gloves, can help in reducing the risk of a person touching a surface. However, in certain situations, surfaces are exposed or the surface covers may be contaminated. In addition, people may not carry personal protective equipment all the time.

The main risk of either contaminating a surface or touching a contaminated surface is related to people touching their faces before or after touching a surface. Notably, the U.S. Centers for Disease Control and Prevention and health organizations worldwide have issued guidelines for people not touching their faces and cleaning their hands frequently, especially after touching potentially contaminated surfaces. Specifically, the Association for Professionals in Infection Control and Epidemiology (APIC) has clearly established that to help prevent infections, people should keep their hands away from their eyes, nose, and mouth. When people touch contaminated surfaces, or others who are sick, their hands can get contaminated with germs. Despite the issued guidelines for people to avoid touching their face with potentially contaminated hands and those for washing their hands frequently, APIC has noted that it is estimated that people touch their face about 23 times per hour, and the germs on their hands can take up residence in their mucosa membranes, causing infections, including pneumonia, flu, or COVID-19. The reason is that for most people touching their face is an unconscious act, which leads to the risk for people to contaminate themselves or others.

One common instance in which people touches a surface with high risk of contamination is when handling shopping carts. Other instances include people touching the handle of carrying containers or bags, exercise or weightlifting bars, and seat frames. Typically, the handle bar of shopping carts is touched by dozens of different people every day, which exponentially increases the risk of the handles become contaminated. Moreover, despite efforts of cleaning the handle bars of shopping carts, there is still a risk for the handle bar to remain contaminated due to defective cleaning or the use of inadequate cleaners. Specifically, the use of protective coverings associated with the use of a shopping cart handle bar has been addressed in the prior art, as described in U.S. Pat. No. 5,715,571 to Fasano. However, these efforts have been aimed to provide an apparatus primarily developed for protecting an infant mouth's from a shopping cart handle and for facilitating entertainment for the infant during shopping. In particular, this attempt is made to use a protective cover having an attachment means for attaching overlapped lateral portions of the cover to secure the cover when it is wrapped around the bar. Moreover, the cover comprises apparatuses for both securing toys and supporting bottles for the infant.

Additional efforts have been made to get more comfortable hand grip onto a handle bar, such as a handlebar of a baby stroller, bicycles, weightlifting bars, or golf clubs. However, handlebar grips are generally fixed onto the handlebar and cannot be replaced by the user. In general, most removable handlebar grip assemblies require either access to at least one open end of the handlebar or complex securing mechanisms employing screws and other types of fasteners, as described in U.S. Pat. No. 6,263,759 to Hollingsworth et al. and U.S. Pat. No. 6,615,687 to Bendetti et al. However an open end of the handle bar is not always possible for applications such as a handlebar of a shopping cart, a baby stroller, or carrying containers or bags. Removable hand grips are known that can be attached around a handle bar without the need for having an open end, as disclosed in U.S. Pat. No. 5,511,445 to Hildebrandt, but these grips may move to undesired positions over time, resulting ineffective for their intended purpose. Another recent attempt has been made to provide a removable hand grip for a handlebar which does not move and is easier to attach to the handlebar, as described in U.S. Pat. No. 10,532,758 to Barenbrug et al. However, this solution still requires at least two coupling elements comprising one or more protrusions arranged to be inserted into one or more holes or recesses of the bar.

Thus, there still remains a need in the art for practical, effective, and quickly and easily installable and removable protective devices capable of preventing a person to physically touch potentially contaminated surfaces, such as a the surface of a handlebar that avoid the problems of prior art devices.

### SUMMARY OF THE INVENTION

A removable handle cover device for wrapping around a bar to prevent a user's hands to be in direct contact with the bar is disclosed herein. One or more aspects of exemplary embodiments provide advantages while avoiding disadvantages of the prior art. The handle cover comprises at least one piece of material wrappable around a handle bar, one or more spring steel elements, and a releasing mechanism for quickly removing the handle cover from the bar. The device is operative to be quickly installed and removed from the handle bar by the user with a single action, while physically isolating the user's hands from the bar. The handle cover is able to prevent the user from being exposed to contaminants on or to contaminate the surface of the bar by increasing the efficacy in the implementation and performance of proven healthy practices, reducing the risk of contamination with and spreading of contagious diseases. Moreover, the removable handle cover device is able to provide a firm hand grip for a bar, while being compact, lightweight, reliable, and customizable with multiple looks and patterns. In addition, the device is susceptible of low cost to consumers.

In particular, the removable handle cover device comprises a flexible material, which may include a fabric, cloth, foam, plastic, padding, or the like, that is wrappable around a handle bar. The device further comprises a spring-steel element attached to the flexible material. The spring-steel element can be quickly and easily activated by the user into a grasping state for wrapping around the bar. Furthermore, the user can quickly and easily release the tension in the spring-steel element by pulling a string element, such that the spring-steel element returns to a deactivated state and the device can be removed from the bar. The string element may be a strip, loop, string, thread, cord, lace, line, cable, wire, chain, and the like, or a combination thereof. The device subject of the present invention, preferably comprises multiple spring-steel elements properly spaced to effectively wrap around a bar of different lengths.

Once installed around a handle bar, such as a shopping cart handle bar, a carrying handle, exercise or weightlifting bars, golf clubs, or a seat frame, the device offers protection to the user by providing a layer of physical isolation between a user's hands and the handle bar. Accordingly, the user is prevented from touching the bar, reducing the user's risk to be exposed to a potentially contaminated surface or to contaminate such surface.

By physically isolating the user's hands from the handle bar, the user is prevented from touching the bar. This prevention ultimately helps the user to comply with proven healthy and safety practices to reduce the risk of contamination with and spreading of contagious diseases. Thus, the apparatus and method allow the user a more effective performance of activities, while contributing to control the spreading of contagious diseases, by reducing the user's exposure and risk to get contaminated or contaminate others.

### BRIEF DESCRIPTION OF THE DRAWINGS

The numerous advantages of the present invention may be better understood by those skilled in the art by reference to the accompanying drawings in which:

FIG. 1 shows a top view of a single-spring-steel element handle cover for wrapping around a bar, in an unwrapped condition, in accordance with a first embodiment, wherein the singe-spring-steel element is unassembled.

FIG. 2 shows a top view of a multiple-spring-steel elements handle cover for wrapping around a bar, in an unwrapped condition, in accordance with a second embodiment, wherein the multiple-spring-steel elements are unassembled.

FIG. 3 shows a cross-sectional side view of a handle cover along its longest dimension, comprising a plurality of spring steel elements, for wrapping around a bar in accordance with a third embodiment.

FIG. 4 shows a perspective view of a handle cover in a wrapped condition.

### DETAILED DESCRIPTION OF THE INVENTION

The following description is of particular embodiments of the invention, set out to enable one to practice an implementation of the invention, and is not intended to limit the preferred embodiment, but to serve as a particular example thereof. Those skilled in the art should appreciate that they may readily use the conception and specific embodiments disclosed as a basis for modifying or designing other methods and systems for carrying out the same purposes of the present invention. Those skilled in the art should also realize that such equivalent assemblies do not depart from the spirit and scope of the invention in its broadest form.

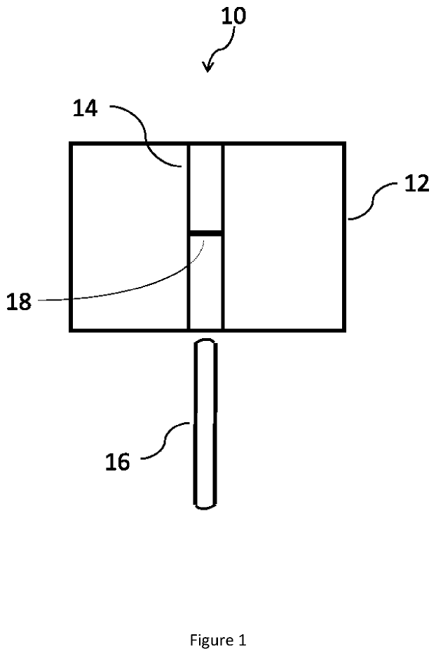

FIG. 1 shows a top view of a single-spring-steel element handle cover 10 for wrapping around a bar, in an unwrapped condition, in accordance with a first embodiment, wherein the single-spring-steel element is unassembled. Particularly, handle cover 10 comprises a piece of an elongated covering element 12, having a longer side and a shorter side; a pocket 14 disposed approximately at the middle section of covering element 12 along the shorter side of covering element 12 and having a longer side and a shorter side; a grasping mechanism further comprising a spring-steel element, such as a strip 16, that at least partly inserts into pocket 14 and may be capable to activate a grasp of covering element 12 for wrapping around the bar; and a releasing mechanism further comprising a pullable string element 18 capable to deactivate the grasp of spring-steel element 16. Preferably, spring-steel element strip 16 fully inserts into pocket 14.

Covering element 12 may be able to wrap around a handle bar disposed along the side substantially perpendicular to spring-steel element strip 16. In this particular configuration, covering element 12 wraps along its shorter dimension to be able to grasp a bar having a periphery of a length in which spring-steel element strip 16 is capable to attach to the bar. Preferably, the length of the periphery of the bar is smaller than the length of the shorter side of elongated covering element 12. More preferably, the length of the periphery of the bar is equal to the length of the shorter side of elongated covering element 12. However, for bar periphery lengths larger than the length of the shorter side of elongated covering element 12, handle cover may still grasp the bar, especially if the spring-steel element strip 16 length is at least one half of the periphery length of the bar. In general, spring-steel element 16 has two states, a first deactivated state in which spring-element 16 is in a resting position, and a second activated state in which spring-steel element 16 is exerting a force, while bending at its middle section such that its ends get closer to each other.

Furthermore covering element 12 comprises at least one layer of a flexible component, which may include a fabric, cloth, foam, plastic, padding, or the like. Preferably, covering element 12 has a rectangular shape and comprises a padded component for providing a comfortable grasp of the bar to a user. More preferably the padded component is embedded in between two layers of another flexible component, such as cloth, to provide a good grip of handle cover 10 to the bar and by the user. Most preferably, pocket 14 is disposed approximately at the middle section of covering element 12 along the shorter side of covering element 12, and configured such that spring-steel element strip 16 can be inserted in pocket 14 and remains in place during use of handle cover 10. Preferably pocket 14 has dimensions slightly larger than the dimensions of spring-steel element strip 16 and has an opening for having access to spring-steel element strip 16 after being inserted into pocket 14.

Moreover, a pullable string element 18 is attached to covering element 12 on the top side of handle cover 10. Preferably, string element 18 is sewed to covering element 12 forming a loop approximately at the middle section of pocket 14 along the shortest side of pocket 14. More preferably, string element 18 forms a closed loop dimensioned such that a finger of a user can be inserted into the loop to pull string element 18 for deactivating the grasp of spring-steel element 16. Deactivation of spring-steel element 16 occurs by the pulling action of the loop forming string element 18, which forces spring-steel element 16 to change from an activated state to a deactivated state. In addition, string element 18 can be used as a handle to remove handle cover 10, without touching any potentially contaminated surface of the bar, using just a finger.

Those skilled in the art will realize that alternatively spring-steel element strip 16 may be attached to material layer 12, such that a single layer of covering element 12 may be used and there is no need of having pocket 14 to implement handle cover 10. Likewise, those versed in the art will recognize that string element 18 may be alternatively secured by gluing, stitching, fastening, embroidering, or inserting it through an opening in pocket 14 or in covering element 12. Likewise, a hook-and-loop fastener, such as a Velcro type can be used to attach string element 18 to covering element 12 or to secure any component of handle cover 10 or an external component, such as a sensor, a device, a pocket, or a holder, to handle cover 10.

During normal use, handle cover 10 can be quickly installed by placing covering element 12 along its longest dimension over a bar. Then a user slightly can bend spring-steel element strip 16 by pushing the ends of spring-steel element strip 16 towards the bar, using only two fingers, in order to activate the grasping state of spring-steel element strip 16 and wrap handle cover 10 around the bar. As a result, the user is able to grasp the bar, while handle cover 10 physically isolates the user's hand from the bar. This prevents the user's hand from touching the bar and reduces the risk of contamination with and spreading of contagious diseases. Likewise, the user can quickly remove handle cover 10 from the bar by inserting a finger in and pulling the loop formed by string element 18, which releases the tension in spring-steel element strip 16, such that spring-steel element strip 16 returns to the deactivated state.

Those skilled in the art will realize that alternatively designs, decorations, or themes may be incorporated into at least part of covering element 12, using transparent or non-transparent materials. In addition, covering element 12 may have various shapes other than rectangular, including squared, circular, elliptical, triangular, and irregular shapes. Moreover, handle cover 10 may further comprise one or more sections of a foldable lip along a part of at least one edge of handle cover 10 to allow an extension of the dimensions of handle cover 10 to cover a longer or wider handle bar.

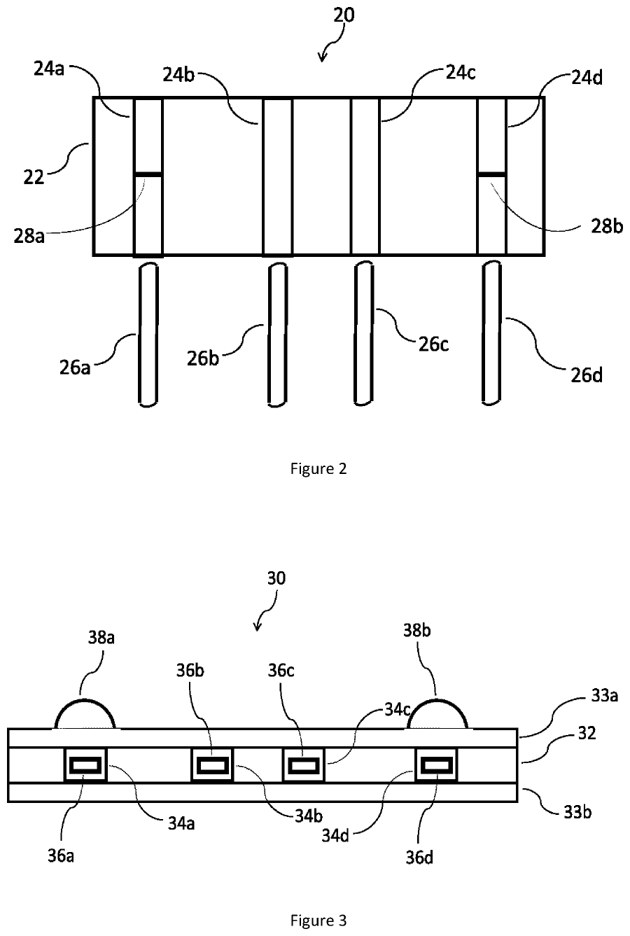

In accordance with a second embodiment, FIG. 2 shows a top view of a multiple-spring-steel elements handle cover 20 for wrapping around a bar, in an unwrapped condition, wherein the multiple-spring-steel elements are unassembled. In particular, handle cover 20 comprises an elongated covering element 22, having a longer side and a shorter side; a plurality of pockets 24a, 24b, 24c, and 24d disposed along the shorter side of covering element 22; a plurality of spring-steel strips 26a, 26b, 26c, and 26d that at least partly insert into pockets 24a, 24b, 24c, and 24d, respectively, and are capable to activate a grasp of covering element 22 for wrapping around the bar; and a set of pullable string elements 28a and 28b capable to deactivate the grasp of spring-steel element 16. Covering element 22 has a middle section and two end sections at opposite ends of the middle section. Preferably, pocket 24a and spring-steel strip 26a and pocket 24d and spring-steel strip 26d are disposed approximately at each of the two end sections of covering element 22. Likewise, pockets 24b, 24c and spring-steel strips 26b, 26c are disposed at the middle section of covering element 22. More preferably, pockets 24a, 24b, 24c, 24d and spring-steel strips 26a, 26b, 26c, 26d are disposed evenly distributed along the shorter side of covering element 22.

Covering element 22 may be able to wrap around a handle bar disposed along the side substantially perpendicular to spring-steel element strips 26a, 26b, 26c, 26d. In this particular configuration, covering element 22 wraps along its shorter dimension to be able to grasp a bar having a periphery of a length in which spring-steel element strip 26a, 26b, 26c, 26d may be capable to attach to the bar. Moreover, a user may be able to grasp handle cover 20 with both hands.

Furthermore, covering element 22 comprises at least one layer of a flexible component, which may include a fabric, cloth, foam, plastic, padding, or the like, or a combination thereof. Preferably, covering element 22 comprises a padded component for providing a comfortable grasp of the bar to a user. More preferably the padded component is embedded in between two layers of another flexible component, such as cloth, to provide a good grip of handle cover 20 to the bar and to the user. Most preferably, pockets 24a, 24b, 24c, 24d are configured such that spring-steel element strips 26a, 26b, 26c, 26d can be inserted in pockets 24a, 24b, 24c, 24d, respectively, and remain in place during use of handle cover 20. Preferably pockets 24a, 24b, 24c, 24d have dimensions slightly larger than the dimensions of spring-steel element strips 26a, 26b, 26c, 26d, and each has an opening for having access to spring-steel element strips 26a, 26b, 26c, 26d after being inserted into pockets 24a, 24b, 24c, 24d.

Moreover, pullable string elements 28a, 28b are attached to covering element 22 on the top side of handle cover 20. Preferably, string elements 28a, 28b are sewed to covering element 22 forming a loop approximately at the middle section of and along the shortest side of pockets 24a, 24d, respectively. More preferably, string elements 28a, 28b form a closed loop dimensioned such that a finger of a user can be inserted into the loop to pull string elements 28a, 28b for deactivating the grasp of spring-steel elements 26a, 26b, 26c, 26d. In this particular configuration, handle cover 20 may be quickly installed around a bar by slightly bending spring-steel elements 26a, 26b, 26c, 26d towards the bar using two fingers. However, the user can quickly remove handle cover 20 from the bar by inserting a finger in and slightly pulling either loop formed by string element 28a or string element 28b, without touching any potential contaminated surface.

Those skilled in the art will realize that handle cover 20 may be split into two separate parts at its middle section along the shortest side, such that each part can be installed around a bar at a variable distance from each other. This will allow handle cover 20 to be installed in a bar having a smaller section available. Specifically for installing handle cover 20 in a shopping cart handle bar in which the handle bar is connected to another structure and has not an open end, resulting in the inability of installing handle cover 20 as a single unit as described in reference to FIG. 2. Additionally, these two parts may be connected or not by a string or the like. Moreover, these two parts might be detachable such that handle cover may be used as a single unit or as two separate units. Moreover, handle cover 20 may comprise multiple detachable sections, wherein each of these sections is individually capable of wrapping around a bar and attachable to at least another of these sections.

According to a third embodiment, FIG. 3 shows a cross-sectional side view of a handle cover 30 along its longest dimension, comprising a layer of an inner covering element 32 disposed in between two layers of an outer material 33a and 33b disposed at opposite sides of inner covering element 32. Additionally, handle cover 30 further comprises a plurality of pockets 34a, 34b, 34c, and 34d, disposed along the shorter side of handle cover 30; a plurality of spring-steel strips 36a, 36b, 36c, and 36d that at least partly insert into pockets 34a, 34b, 34c, and 34d, respectively, and are capable to activate a grasp of handle cover 30 for wrapping around the bar; and a set of pullable string elements 38a and 38b, attached to outer material 33a, for deactivating the grasp of spring-steel strips 36a, 36b, 36c, 36d.

In this particular configuration, inner covering element 32 comprises a flexible component, which may include a fabric, stuff, cloth, foam, plastic, padding, or the like, or a combination thereof. Preferably, inner covering element 32 comprises a padded component for providing a comfortable grasp of the bar to a user. More preferably, the padded component of covering element 32 is embedded in between two layers of outer material 33a, 33b, which comprises a flexible component, such as cloth, to provide an improved grip of handle cover 30 to the bar and to the user. Most preferably, pockets 34a, 34b, 34c, 34d are configured such that spring-steel element strips 36a, 36b, 36c, 36d can be inserted in pockets 34a, 34b, 34c, 34d, respectively, and remain in place during use of handle cover 30. Preferably pockets 34a, 34b, 34c, 34d have dimensions slightly larger than the dimensions of spring-steel element strips 36a, 36b, 36c, 36d, and each has an opening for having access to spring-steel element strips 36a, 36b, 36c, 36d after being inserted into pockets 34a, 34b, 34c, 34d.

Moreover, pullable string elements 38a, 38b are attached to outer material 33a on the top side of handle cover 30. Preferably, string elements 38a, 38b are sewed to outer material 33a forming a loop approximately at the middle section of and along the shortest side of pockets 34a, 34d, respectively. More preferably, string elements 38a, 38b form a closed loop dimensioned such that a finger of a user can be inserted into the loop to pull string elements 38a, 38b for deactivating the grasp of spring-steel elements 36a, 36b, 36c, 36d. In this particular configuration, handle cover 30 may be quickly installed around a bar by slightly bending spring-steel elements 36a, 36b, 36c, 36d towards the bar using two fingers. However, the user can quickly remove handle cover 30 from the bar by inserting a finger in and slightly pulling either loop formed by string element 38a or string element 38b, without touching the potentially contaminated bar.

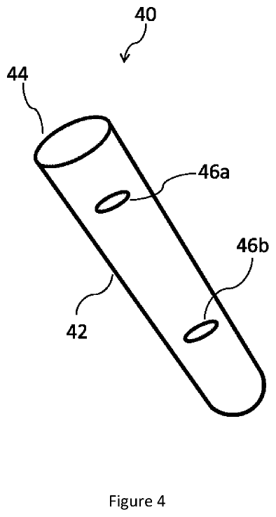

FIG. 4 shows a perspective view of a handle cover 40 in a wrapped condition, corresponding to spring-steel elements (not shown) being in an activated state. Handle cover 40 comprises an covering element 42, which wraps around forming a cylindrical or tubular section with no caps. In this wrapped condition, handle cover 40 defines a circumference 44, corresponding to a circular cross-section of a cylinder, corresponding to a handle bar. Preferably, the length of circumference 44 is larger than a periphery of a cross-section of a handle bar (not shown) around which handle cover 40 would be wrapping. More preferably, the length of circumference 44 is equal to the length of the periphery of the cross-section of the handle bar (not shown) around which handle cover 40 would be wrapping. However, for a length of circumference 44 smaller than the periphery of the cross-section of the handle bar (not shown) around which handle cover 40 would be wrapping, handle cover 40 may grasp the handle bar (not shown), as described in reference to FIG. 1. Those versed in the art will realize that the cross-section of a handle bar may have other shapes than circular, including elliptical, rectangular, or irregular. Accordingly, handle cover 40 may be able to at least partly wrap around such handle bars to provide physical isolation between a user's hand and the bar.

In this particular configuration, handle cover 40 further comprises two pull string elements 46a and 46b for quickly releasing handle cover 40 from a wrapped condition or activated state to an unwrapped condition or deactivated state and allowing the removal of handle cover 40 from the handle bar without touching any potentially contaminated surface.

The removable handle cover wrappable around a bar for physically isolating a user's hands from such bar has been disclosed herein in an illustrative manner, and it is to be understood that the terminology which has been used is intended to be in a descriptive rather than in a limiting nature. Any embodiment herein disclosed may include one or more aspects of the other embodiments. Those skilled in the art will recognize that many modifications and variations of the invention are possible in light of the above teachings.

We claim:

1. A removable handle cover for covering a handle bar to physically isolate said handle bar from a user's hand, said removable handle cover comprising:
a. a covering element wrappable around said handle bar, said covering element comprising a flexible component having a first side defining a width and a second side defining a length;
b. a grasping mechanism comprising at least one spring-steel element having an activated grasping state to secure said covering element wrapped around said handle bar and a deactivated grasping state to release a grasping of said covering element around said handle bar; and
c. a releasing mechanism comprising at least one string element to enable said deactivated grasping state of said spring-steel element to remove said grasping of said covering element around said handle bar,
wherein said at least one spring-steel element of said grasping mechanism and said at least one string element of said releasing mechanism are integrated with said flexible component of said covering element.

2. The removable handle cover of claim 1, wherein said covering element further comprises at least one pocket wherein said at least one spring-steel element at least partly inserts into said at least one pocket.

3. The removable handle cover of claim 2, wherein said at least one spring-steel element fully inserts into said at least one pocket.

4. The removable handle cover of claim 1, further comprising at least one section of a foldable lip along a part of at least one edge of said flexible component to allow an extension of at least one dimension of said flexible component to cover a handle bar having larger dimensions.

5. The removable handle cover of claim 1, wherein said first side of said flexible component is shorter than said second side of said flexible component.

6. The removable handle cover of claim 1, wherein said flexible component of said covering element comprises a plurality of detachable sections to allow shortening at least one dimension of said handle cover to facilitate installation of said handle cover in said handle bar, wherein said handle bar has a section available for installation of said handle cover that is too small to fit said handle cover without detaching at least one of said plurality of detachable sections.

7. The removable handle cover of claim 1, wherein said flexible component of said covering element is adaptable to cover said handle bar, wherein said handle bar has a cross-section shaped as an element selected from a group of elliptical, rectangular, circular, irregular, and a combination thereof.

8. The removable handle cover of claim 1, wherein said flexible component of said covering element comprises a flexible material, selected from the group of fabric, cloth, foam, plastic, padding, and a combination thereof, that is wrappable around said handle bar.

9. The removable handle cover of claim 1, wherein at least one of said at least one spring-steel element of said grasping mechanism and said at least one string element of said releasing mechanism are integrated with said flexible component of said covering element by a means selected from a group of gluing, stitching, fastening, embroidering, sewing, insertion through an opening in said covering element, and a combination thereof.

10. The removable handle cover of claim 1, wherein said releasing mechanism comprises a pullable string element forming a closed loop dimensioned such that a finger of said user can be inserted into the loop to pull said pullable string element for achieving at least one of deactivating the grasp of said spring-steel element and using said closed loop as a handle to remove said removable handle cover from said handle bar without touching said handle bar.

11. The removable handle cover of claim 1, wherein said at least one spring-steel element is settable in at least one of said activated grasping state and said deactivated grasping state by a single action of said user.

12. The removable handle cover of claim 11, wherein said spring-steel element is configurable to allow said user to set said deactivated grasping state using one finger of said user.

13. The removable handle cover of claim 11, wherein said spring-steel element is configurable to allow said user to set said activated grasping state using two fingers of said user.

14. The removable handle cover of claim 1, wherein said covering element is disposed in between two layers of an outer material and wherein each of said two layers of said outer material is disposed at opposite sides of said covering element to provide an improved grip of said handle cover to said handle bar and to said user.

15. The removable handle cover of claim 1, wherein a disposition of said at least one spring-steel element is evenly distributed along at least one of said first side and said second side of said covering element.

16. The removable handle cover of claim 1, wherein said spring-steel element has an elongated configuration and wherein a larger side of said spring-steel element is disposed along at least one of said first side and said second side of said covering element and wherein said handle cover wraps around said handle bar along said larger side of said spring-steel element.

17. The removable handle cover of claim 1, wherein said at least one string element is an item selected from a group of a strip, a loop, a string, a thread, a cord, a lace, a line, a cable, a wire, a chain, and a combination thereof.

18. The removable handle cover of claim 1, further comprising at least one hook-and-loop fastener for attaching an external item to said handle cover.

19. The removable handle cover of claim 1, further comprising a decorative item.

20. The removable handle cover of claim 1, further comprising a theme item.
